(19) United States
(12) Patent Application Publication
(10) Pub. No.: US 2025/0299266 A1
(43) Pub. Date: Sep. 25, 2025

(54) SCROLLING AND VIEWING CONTENT BY MULTIPLE USERS

(71) Applicant: Snap Inc., Santa Monica, CA (US)

(72) Inventor: William David Nuckols, Seattle, WA (US)

(21) Appl. No.: 18/609,854

(22) Filed: Mar. 19, 2024

(51) Int. Cl. G06Q 50/00; G06F 3/04817; G06F 3/0485

(52) U.S. Cl. CPC G06Q 50/01; G06F 3/04817; G06F 3/0485

(57) ABSTRACT

Multiple users can simultaneously view and scroll content from a collection of content items working on separate user systems. Example methods include generating a group feed, determining, based on metadata associated with the first user and metadata associated with the second user, a first content item of the plurality of content items, and causing the first content item to be displayed on a first computing device and on a second computing device. The methods may further include accessing, from the first user or the second user, an indication of a reaction to the first content item, accessing, from the first user or the second user, an indication to scroll to a second content item of the plurality of content items, and determining, the second content item, based on the metadata of the first user, the metadata of the second user, and the reaction to the first content item.

### TECHNICAL FIELD

Examples of the present disclosure relate generally to viewing and scrolling content items by multiple users where the content items are selected from a collection of content items. More particularly, but not by way of limitation, examples of the present disclosure relate to determining a next content item based on metadata associated with the multiple users and enabling the multiple users to react to, view, and scroll the content items where the multiple users are on separate user systems.

### BACKGROUND

Applications that scroll content items where the content items may be selected from a collection of content items within an interaction platform have become ubiquitous. Additionally, users increasingly want more and more functionality from the applications and for the functionality to be easier to use. But often it is difficult to add the functionality and to make the functionality easy to use.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system, according to some examples, that has both client-side and server-side functionality.

FIG. 3 is a diagrammatic representation of a data structure as maintained in a database, according to some examples.

FIG. 4 is a diagrammatic representation of a machine in the form of a computer system within which a set of instructions may be executed to cause the machine to perform any one or more of the methodologies discussed herein, according to some examples.

FIG. 5 is a block diagram showing a software architecture within which examples may be implemented.

FIG. 6 is a perspective view of a wearable apparatus in the form of glasses, in accordance with some examples.

FIG. 7 illustrates a system for scrolling and viewing content by multiple users, in accordance with some examples.

FIG. 8 is a schematic diagram illustrating a system for scrolling and viewing content by multiple users, in accordance with some examples.

FIG. 9 illustrates a system for scrolling and viewing content by multiple users, in accordance with some examples.

FIG. 10 illustrates a system for scrolling and viewing content by multiple users, in accordance with some examples.

FIG. 11 illustrates a system for scrolling and viewing content by multiple users, in accordance with some examples.

FIG. 12 illustrates a method for scrolling and viewing content by multiple users, in accordance with some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

Often applications for viewing and scrolling content items from a plurality of content items only enable a single user system to view the content items and do not permit participation from other users. Additionally, often the selection of the next content item is determined based on metadata associated with just the user of the application.

A technical challenge is how to enable users, on separate user systems, to participate with one another while viewing content items. The technical challenge is addressed by a group feed application that enables users to simultaneously view, react to, and scroll, the same content item. In some examples, metadata from each of the users is used to determine a next content item. In some examples, metadata is collected during the group viewing and used to determine the next content item. For example, if users were viewing images that they took over summer vacation, and if the users reacted with a “thumbs up” for content that included smiling or happy people, then the group feed application would favor images where people were smiling or happy.

Additionally, in some examples, the group feed application enables the users to select where the content items come from. For example, the content items may be collections of images stored locally on the user systems or the content items may be from a large collection of content items accessible to an interaction platform. The group feed application, in some examples, selects content items based on multiple feeds of content items. Moreover, the group feed application enables the users to see the reactions from other users and set configuration permissions. In some examples, the group feed application detects when friends are geographically near and offers to add the friends to the group feed.

### Networked Computing Environment

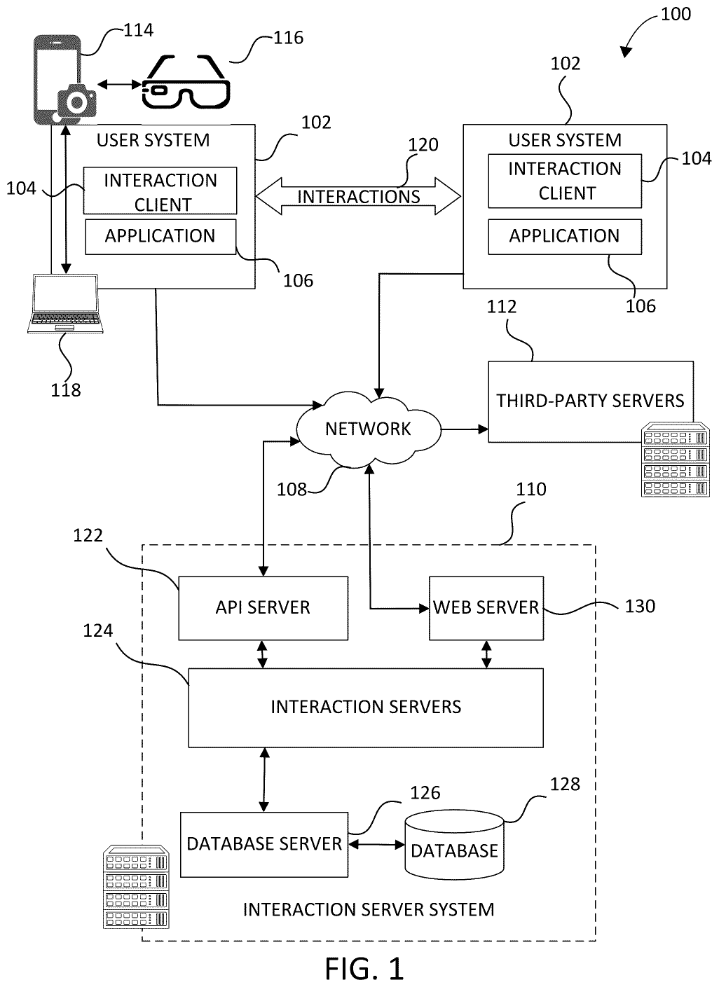

FIG. 1 is a block diagram showing an example interaction system 100 for facilitating interactions (e.g., exchanging text messages, conducting text audio and video calls, or playing games) over a network. The interaction system 100 includes multiple client systems, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems), an interaction server system 110 and third-party servers 112). An interaction client 104 can also communicate with locally hosted applications 106 using Applications Program Interfaces (APIs).

Each user system 102 may include multiple user devices, such as a computing device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, social network information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

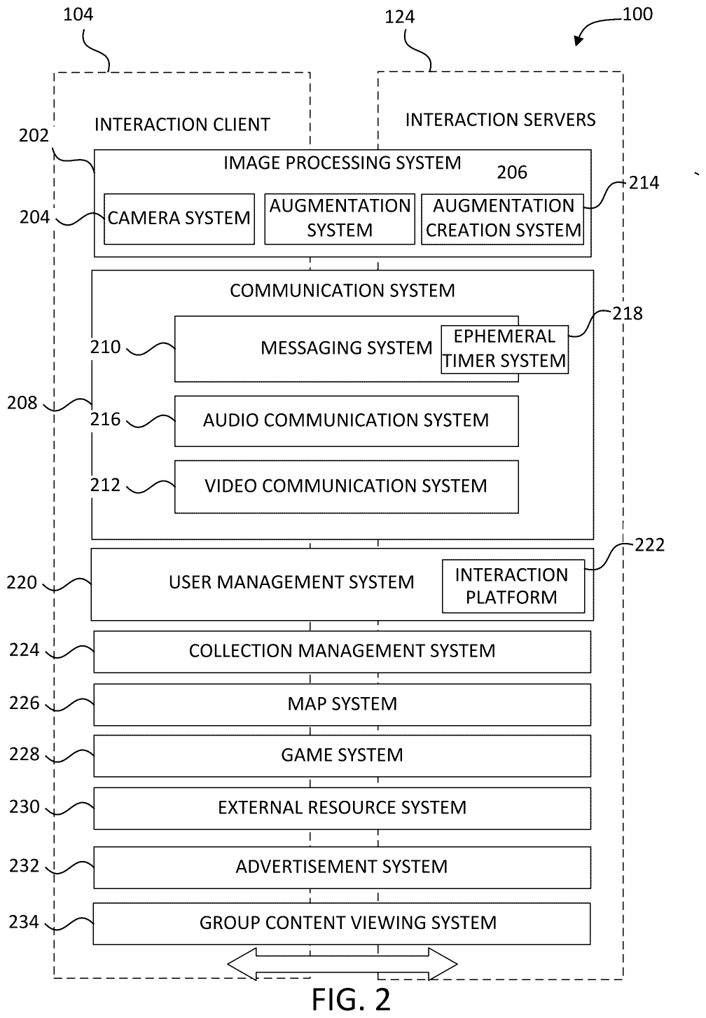

The Application Program Interface (API) server 122 receives and transmits interaction data (e.g., commands and message payloads) between the interaction servers 124 and the client systems (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104). The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 508 of a user system 102. These augmentations are selected by the augmentation system 206 and presented to a user of an interaction client 104, based on a number of inputs and data, such as for example:
Geolocation of the user system 102; and
Social network information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system 218) that, based on duration and display parameters associated with a message or collection of messages (e.g., a story), selectively enable access (e.g., for presentation and display) to messages and associated content via the interaction client 104. Further details regarding the operation of the ephemeral timer system 218 are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 220 is operationally responsible for the management of user data and profiles, and includes an interaction platform that maintains information regarding relationships between users of the interaction system 100.

A collection management system 224 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 224 may also be responsible for publishing an icon that provides notification of a particular collection to the user interface of the interaction client 104. The collection management system 224 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 224 employs machine vision (or image recognition technology) and content rules to curate a content collection automatically. In certain examples, compensation may be paid to a user to include user-generated content into a collection. In such cases, the collection management system 224 operates to automatically make payments to such users to use their content.

A map system 226 provides various geographic location functions and supports the presentation of map-based media content and messages by the interaction client 104. For example, the map system 226 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 228 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 230 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A Web ViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 232 operationally enables the purchasing of advertisements by third parties for presentation to end-users via the interaction clients 104 and also handles the delivery and presentation of these advertisements.

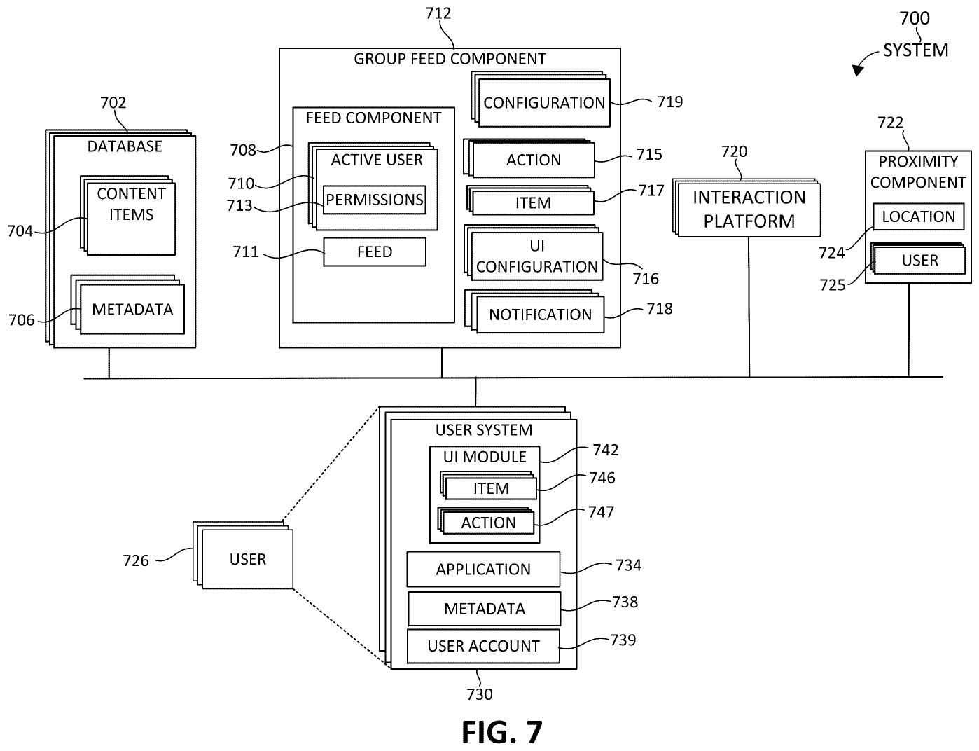

The group content viewing system 234 supports or is the same as the, referring to FIGS. 7-11, the group feed component 712, application 734 and/or the proximity component 722. In some examples, the group content viewing system 234 performs one or more functions for the group feed component 712, application 734 and/or the proximity component 722.

Additionally, the group content viewing system 234 can provide the group feed component 712, application 734 and/or the proximity component 722 to user systems 102 and/or head-wearable apparatuses 116. The group content viewing system 234 interacts with the interaction platform 222 by providing services such as determining a next content item 704, delivering communications 812 among user systems 102, and so forth.

### Data Architecture

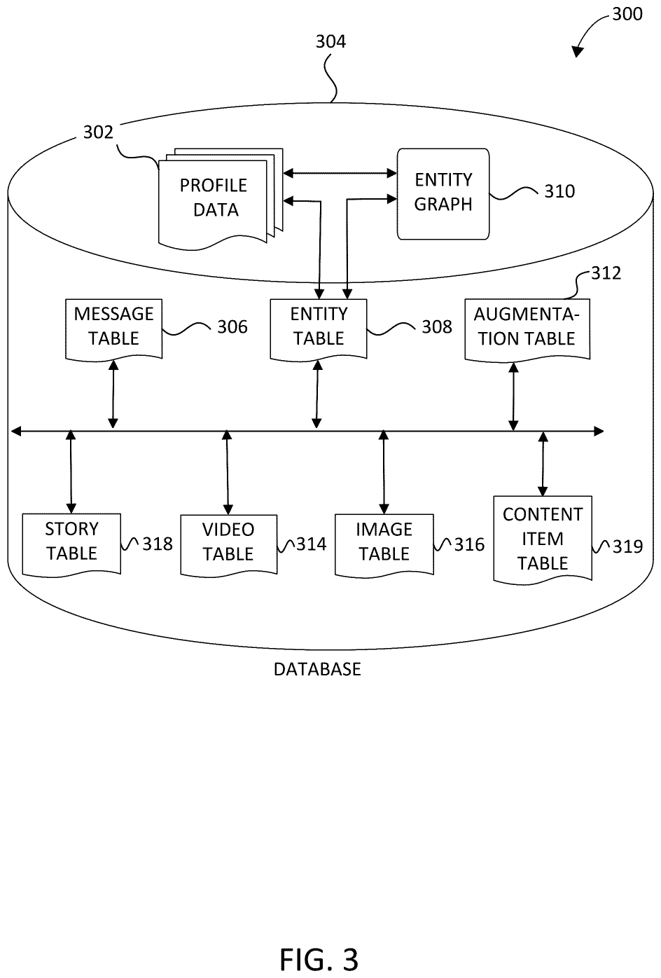

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database).

The database 304 includes message data stored within a message table 306. This message data includes, for any particular message, at least message sender data, message recipient (or receiver) data, and a payload. Further details regarding information that may be included in a message and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes

augmented reality content items (e.g., corresponding to applying “lenses” or augmented reality experiences). An augmented reality content item may be a real-time special effect and sound that may be added to an image or a video.

A story table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

The databases 304 also includes content item table 319. The content item table 319 may be the same or similar as content items 704. The group feed component 712 may search the content items 704 of the content item table 319 to determine a next content item 704, which may be based on metadata 706 that may be stored in the profile data 302.

### Machine Architecture

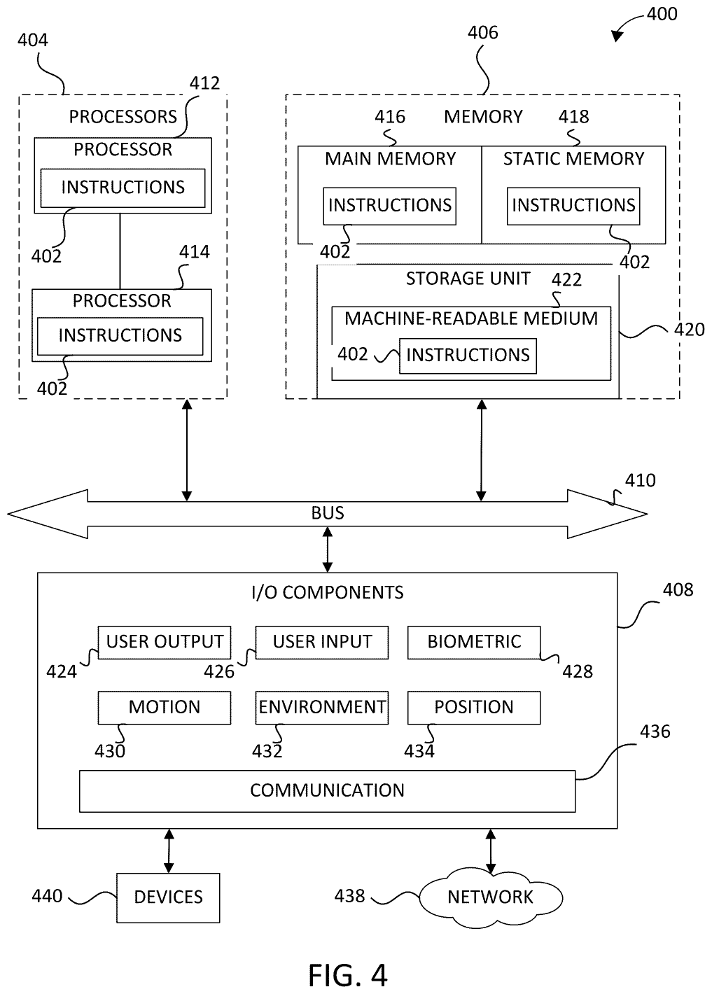

FIG. 4 is a diagrammatic representation of the machine 400 within which instructions 402 (e.g., software, a program, an application, an applet, an app, or other executable code) for causing the machine 400 to perform any one or more of the methodologies discussed herein may be executed. For example, the instructions 402 may cause the machine 400 to execute any one or more of the methods described herein. The instructions 402 transform the general, non-programmed machine 400 into a particular machine 400 programmed to carry out the described and illustrated functions in the manner described. The machine 400 may operate as a standalone device or may be coupled (e.g., networked) to other machines. In a networked deployment, the machine 400 may operate in the capacity of a server machine or a client machine in a server- client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 402, sequentially or otherwise, that specify actions to be taken by the machine 400. Further, while a single machine 400 is illustrated, the term “machine” shall also be taken to include a collection of machines that individually or jointly execute the instructions 402 to perform any one or more of the methodologies discussed herein. The machine 400, for example, may comprise the user system 102 or any one of multiple server devices forming part of the interaction server system 110. In some examples, the machine 400 may also comprise both client and server systems, with certain operations of a particular method or algorithm being performed on the server-side and with certain operations of the particular method or algorithm being performed on the client-side.

The machine 400 may include processors 404, memory 406, and input/output I/O components 408, which may be configured to communicate with each other via a bus 410. In an example, the processors 404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 412 and a processor 414 that execute the instructions 402. The term “processor” is intended to include multi-core processors that may comprise two or more independent processors (sometimes referred to as “cores”) that may execute instructions contemporaneously. Although FIG. 4 shows multiple processors 404, the machine 400 may include a single processor with a single-core, a single processor with multiple cores (e.g., a multi-core processor), multiple processors with a single core, multiple processors with multiples cores, or any combination thereof.

The memory 406 includes a main memory 416, a static memory 418, and a storage unit 420, both accessible to the processors 404 via the bus 410. The main memory 406, the static memory 418, and storage unit 420 store the instructions 402 embodying any one or more of the methodologies or functions described herein. The instructions 402 may also reside, completely or partially, within the main memory 416, within the static memory 418, within machine-readable medium 422 within the storage unit 420, within at least one of the processors 404 (e.g., within the processor's cache memory), or any suitable combination thereof, during execution thereof by the machine 400.

The I/O components 408 may include a wide variety of components to receive input, provide output, produce output, transmit information, exchange information, capture measurements, and so on. The specific I/O components 408 that are included in a particular machine will depend on the type of machine. For example, portable machines such as mobile phones may include a touch input device or other such input mechanisms, while a headless server machine will likely not include such a touch input device. It will be appreciated that the I/O components 408 may include many other components that are not shown in FIG. 4. In various examples, the I/O components 408 may include user output components 424 and user input components 426. The user output components 424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 408 may include biometric components 428, motion components 430, environmental components 432, or position components 434, among a wide array of other components. For example, the biometric components 428 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 430 include acceleration sensor components (e.g., accelerometer), gravitation sensor components, rotation sensor components (e.g., gyroscope).

The environmental components 432 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 434 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 408 further include communication components 436 operable to couple the machine 400 to a network 438 or devices 440 via respective coupling or connections. For example, the communication components 436 may include a network interface component or another suitable device to interface with the network 438. In further examples, the communication components 436 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 440 may be another machine or any of a wide variety of peripheral devices (e.g., a peripheral device coupled via a USB).

Moreover, the communication components 436 may detect identifiers or include components operable to detect identifiers. For example, the communication components 436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 436, such as location via Internet Protocol (IP) geolocation, location via Wi-Fi® signal triangulation, location via detecting an NFC beacon signal that may indicate a particular location, and so forth.

The various memories (e.g., main memory 416, static memory 418, and memory of the processors 404) and storage unit 420 may store one or more sets of instructions and data structures (e.g., software) embodying or used by any one or more of the methodologies or functions described herein. These instructions (e.g., the instructions 402), when executed by processors 404, cause various operations to implement the disclosed examples.

The instructions 402 may be transmitted or received over the network 438, using a transmission medium, via a network interface device (e.g., a network interface component included in the communication components 436) and using any one of several well-known transfer protocols (e.g., hypertext transfer protocol (HTTP)). Similarly, the instructions 402 may be transmitted or received using a transmission medium via a coupling (e.g., a peer-to-peer coupling) to the devices 440.

### Software Architecture

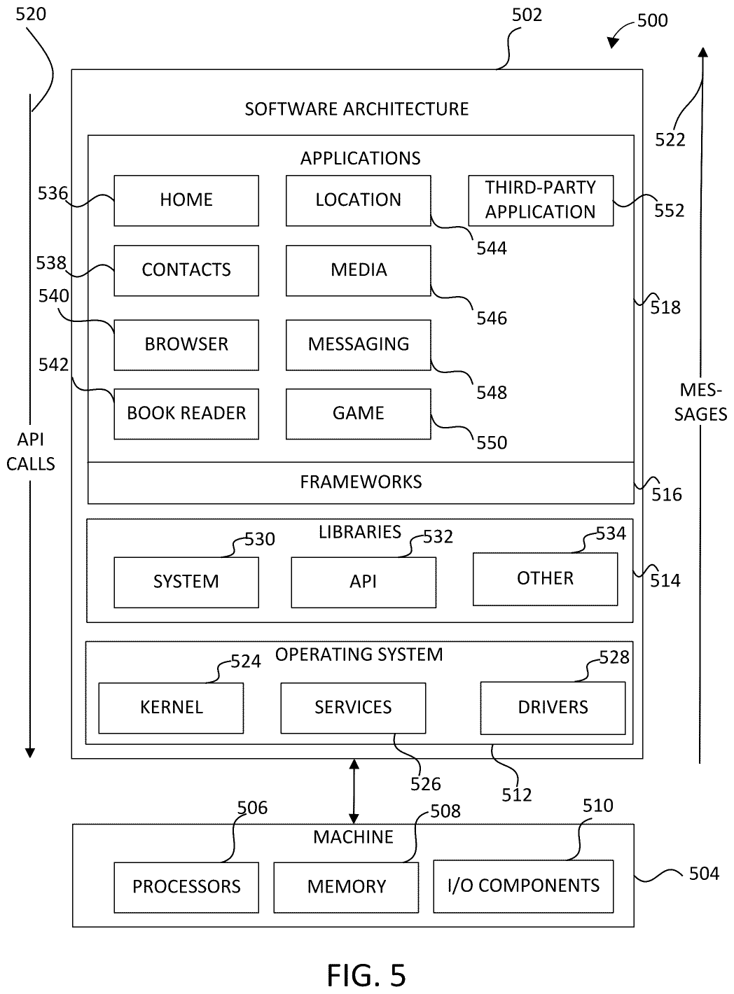

FIG. 5 is a block diagram 500 illustrating a software architecture 502, which can be installed on any one or more of the devices described herein. The software architecture 502 is supported by hardware such as a machine 504 that includes processors 506, memory 508, and I/O components 510. In this example, the software architecture 502 can be conceptualized as a stack of layers, where each layer provides a particular functionality. The software architecture 502 includes layers such as an operating system 512, libraries 514, frameworks 516, and applications 518. Operationally, the applications 518 invoke API calls 520 through the software stack and receive messages 522 in response to the API calls 520.

The operating system 512 manages hardware resources and provides common services. The operating system 512 includes, for example, a kernel 524, services 526, and drivers 528. The kernel 524 acts as an abstraction layer between the hardware and the other software layers. For example, the kernel 524 provides memory management, processor management (e.g., scheduling), component management, networking, and security settings, among other functionalities. The services 526 can provide other common services for the other software layers. The drivers 528 are responsible for controlling or interfacing with the underlying hardware. For instance, the drivers 528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 514 provide a common low-level infrastructure used by the applications 518. The libraries 514 can include system libraries 530 (e.g., C standard library) that provide functions such as memory allocation functions, string manipulation functions, mathematic functions, and the like. In addition, the libraries 514 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 514 can also include a wide variety of other libraries 534 to provide many other APIs to the applications 518.

The frameworks 516 provide a common high-level infrastructure that is used by the applications 518. For example, the frameworks 516 provide various graphical user interface (GUI) functions, high-level resource management, and high-level location services. The frameworks 516 can provide a broad spectrum of other APIs that can be used by the applications 518, some of which may be specific to a particular operating system or platform.

In an example, the applications 518 may include a home application 536, a contacts application 538, a browser application 540, a book reader application 542, a location application 544, a media application 546, a messaging application 548, a game application 550, and a broad assortment of other applications such as a third-party application 552. The applications 518 are programs that execute functions defined in the programs. Various programming languages can be employed to create one or more of the applications 518, structured in a variety of manners, such as object-oriented programming languages (e.g., Objective-C, Java, or C++) or procedural programming languages (e.g., C or assembly language). In a specific example, the third-party application 552 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 552 can invoke the API calls 520 provided by the operating system 512 to facilitate functionalities described herein.

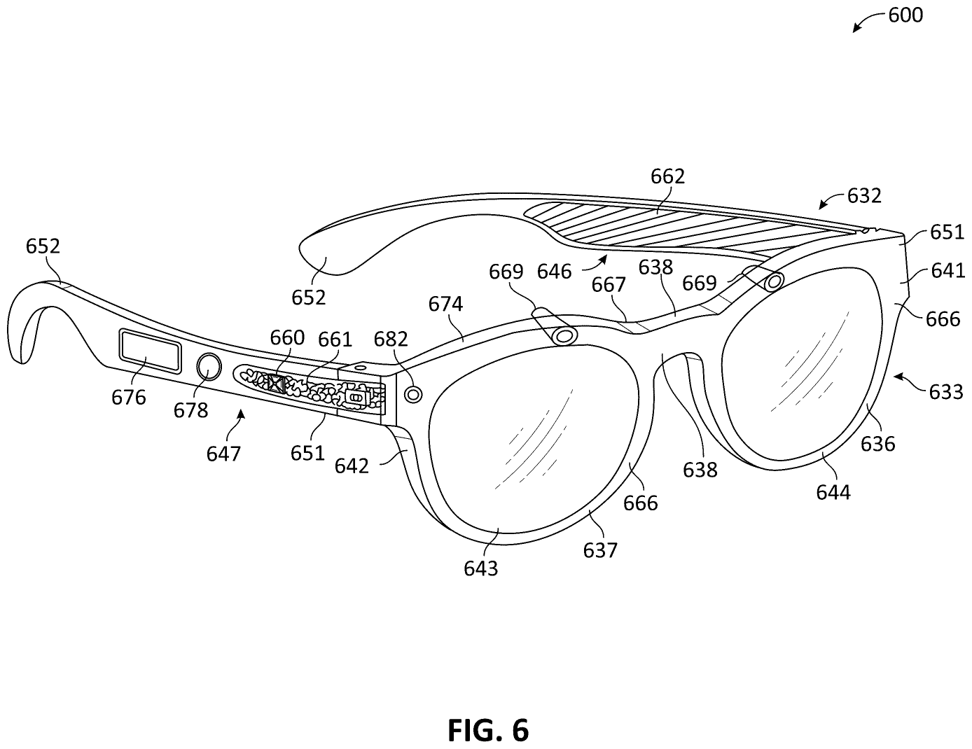

FIG. 6 is a perspective view of a wearable apparatus in the form of glasses 600, in accordance with some examples. The glasses 600 are an article of eyewear including electronics, which operate within a network system for communicating image and video content. FIG. 6 illustrates an example of the wearable apparatus 116. In some examples, the wearable electronic device is termed augmented reality (AR), mixed reality (MR), virtual reality (VR), and/or extended reality (XR) glasses. The glasses 600 can include a frame 632 made from any suitable material such as plastic or metal, including any suitable shape memory alloy. The frame 632 can have a front piece 633 that can include a first or left lens, display, or optical element holder 636 and a second or right lens, display, or optical element holder 637 connected by a bridge 638. The front piece 633 additionally includes a left end portion 641 and a right end portion 642. A first or left optical element 644 and a second or right optical element 643 can be provided within respective left and right optical element holders 636, 637. Each of the optical elements 643, 644 can be a lens, a display, a display assembly, or a combination of the foregoing. In some examples, for example, the glasses 600 are provided with an integrated near-eye display mechanism that enables, for example, display to the user of preview images for visual media captured by cameras 669 of the glasses 600.

The frame 632 additionally includes a left arm or temple piece 646 and a right arm or temple piece 647 coupled to the respective left and right end portions 641, 642 of the front piece 633 by any suitable means such as a hinge (not shown), so as to be coupled to the front piece 633, or rigidly or fixedly secured to the front piece 633 so as to be integral with the front piece 633. Each of the temple pieces 646 and 647 can include a first portion 651 that is coupled to the respective end portion 641 or 642 of the front piece 633 and any suitable second portion 652, such as a curved or arcuate piece, for coupling to the ear of the user. In one example, the front piece 633 can be formed from a single piece of material, so as to have a unitary or integral construction. In one example, the entire frame 632 can be formed from a single piece of material so as to have a unitary or integral construction.

The glasses 600 include a computing device, such as a computer 661, which can be of any suitable type so as to be carried by the frame 632 and, in one example, of a suitable size and shape, so as to be at least partially disposed in one or more of the temple pieces 646 and 647. In one example, the computer 661 has a size and shape similar to the size and shape of one of the temple pieces 646, 647 and is thus disposed almost entirely if not entirely within the structure and confines of such temple pieces 646 and 647.

In one example, the computer 661 can be disposed in both of the temple pieces 646, 647. The computer 661 can include one or more processors with memory, wireless communication circuitry, and a power source. The computer 661 comprises low-power circuitry, high-speed circuitry, location circuitry, and a display processor. Various other examples may include these elements in different configurations or integrated together in different ways. Additional details of aspects of the computer 661 may be implemented as described with reference to the description that follows.

The computer 661 additionally includes a battery 662 or other suitable portable power supply. In one example, the battery 662 is disposed in one of the temple pieces 646 or 647. In the glasses 600 shown in FIG. 6, the battery 662 is shown as being disposed in the left temple piece 646 and electrically coupled using a connection 674 to the remainder of the computer 661 disposed in the right temple piece 647. One or more input and output devices can include a connector or port (not shown) suitable for charging a battery 662 accessible from the outside of the frame 632, a wireless receiver, transmitter, or transceiver (not shown), or a combination of such devices.

The glasses 600 include digital cameras 669. Although two cameras 669 are depicted, other examples contemplate the use of a single or additional (i.e., more than two) cameras 669. For ease of description, various features relating to the cameras 669 will be described further with reference to only a single camera 669, but it will be appreciated that these features can apply, in suitable examples, to both cameras 669.

In various examples, the glasses 600 may include any number of input sensors or peripheral devices in addition to the cameras 669. The front piece 633 is provided with an outward-facing, forward-facing, front, or outer surface 666 that faces forward or away from the user when the glasses 600 are mounted on the face of the user, and an opposite inward-facing, rearward-facing, rear, or inner surface 667 that faces the face of the user when the glasses 600 are mounted on the face of the user. Such sensors can include inward-facing video sensors or digital imaging modules such as cameras 669 that can be mounted on or provided within the inner surface 667 of the front piece 633 or elsewhere on the frame 632 so as to be facing the user, and outward-facing video sensors or digital imaging modules such as the cameras 669 that can be mounted on or provided with the outer surface 666 of the front piece 633 or elsewhere on the frame 632 so as to be facing away from the user. Such sensors, peripheral devices, or peripherals can additionally include biometric sensors, location sensors, accelerometers, or any other such sensors. In some examples, projectors (not illustrated) are used to project images on the inner surface of the optical elements 643, 644 (or lenses) to provide a mixed reality or augmented reality experience for the user of the glasses 600.

The glasses 600 further include an example of a camera control mechanism or user input mechanism comprising a camera control button mounted on the frame 632 for haptic or manual engagement by the user. The camera control button provides a bi-modal or single-action mechanism in that it is disposable by the user between only two conditions, namely an engaged condition and a disengaged condition. In this example, the camera control button is a push button that is by default in the disengaged condition, being depressible by the user to dispose it to the engaged condition. Upon release of the depressed camera control button, it automatically returns to the disengaged condition.

In other examples, the single-action input mechanism can instead be provided by, for example, a touch-sensitive button comprising a capacitive sensor mounted on the frame 632 adjacent to its surface for detecting the presence of a user's finger, to dispose the touch-sensitive button to the engaged condition when the user touches a finger to the corresponding spot on the outer surface 666 of the frame 632. It will be appreciated that the above-described camera control button and capacitive touch button are but two examples of a haptic input mechanism for single-action control of the camera 669, and that other examples may employ different single-action haptic control arrangements.

The computer 661 is configured to perform the methods described herein. In some examples, the computer 661 is coupled to one or more antennas for reception of signals from a GNSS and circuitry for processing the signals where the antennas and circuitry are housed in the glasses 600. In some examples, the computer 661 is coupled to one or more wireless antennas and circuitry for transmitting and receiving wireless signals where the antennas and circuitry are housed in the glasses 600. In some examples, there are multiple sets of antennas and circuitry housed in the glasses 600. In some examples, the antennas and circuitry are configured to operate in accordance with a communication protocol such as Bluetooth™, Low-energy Bluetooth™, IEEE 802, IEEE 802.11az/be, WiFI®, and so forth. In some examples, PDR sensors housed in glasses 600 and coupled to the computer 661. In some examples, the glasses 600 are VR headsets where optical elements 643, 644 are opaque screens for displaying images to a user of the VR headset. In some examples, the computer 661 is coupled to user interface elements such as slide or touchpad 676 and button 678. A long press of button 678 resets the glasses 600. The slide or touchpad 676 and button 678 are used for a user to provide input to the computer 661 and/or other electronic components of the glasses 600. The glasses 600 include one or more microphones 682 that are coupled to the computer 661. The glasses 600 include one or more gyroscopes 680.

### Scrolling and Viewing Content by Multiple Users

FIG. 7 illustrates a system 700 for scrolling and viewing content by multiple users, in accordance with some examples. Interaction platforms 720 are systems that provide a feed of content items 704. Interaction platform 222 of FIG. 2 is an example of interaction platforms 720. Other examples include the most popular social media platforms.

The database 702 comprises structured data such as content items 704 and metadata 706. The database 702 is associated with the interaction platform 720, in accordance with some examples. Referring to FIG. 3, data structures 300 is an example of the database 702. The content items 704 comprise content that can be scrolled through. Example content items 704 include images, stories, videos, augmented reality videos and images, text, icons, job listings, advertisements, for sales or for hire postings, and so forth.

The metadata 706, 738 is information related to the users 726 such as a user icon 908, a display name, information regarding the interactions of the user with content items 704, information regarding friends of the user 726 within one or more of the interaction platforms 720, contact information, address books, demographic information, and other information that may be used by the feed component 708 to select content items 704 for the user 726 to view from the feed 711. In some examples, the metadata 706, 738 is stored decoupled from specific actions performed by the users 726. In some examples, the metadata 706, 738 is encrypted to ensure the security of the metadata 706, 738. In some examples, the metadata 706, 738 includes information regarding other users 726 regarding the content items 704. For example, the metadata 706 includes subjects that are trending or current subjects or news. In some examples, the metadata 706, 738 is associated or stored differently. For example, metadata 738 may be stored associated with the user 726 such as stored locally on a user system 730. The metadata 706 may be stored associated with or as part of an interaction platform 720.

The users 726 include a user system 730, user interface (UI) module 742, application 734, user account 739, and metadata 738. Examples of the user system 730 include, referring to FIG. 1, one or more of the following: the user system 102, the computing device 114, the head-wearable apparatus 116, the computer client device 118, and so forth.

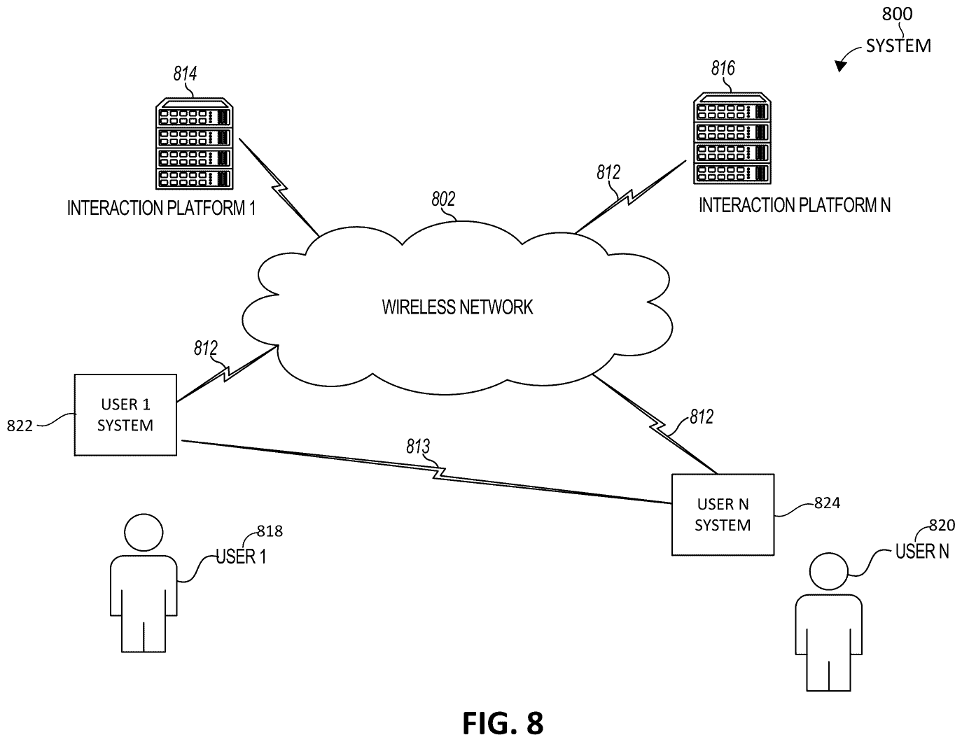

The application 734 runs on the user system 730 and may be the group feed component 712. The application 734 provides the functionality or frontend for the scrolling and viewing content by multiple users. The application 734 may interact with the group feed component 712. In some examples, the group feed component 712 is resident in one or more of the user systems 730 and the user systems 730 communicate with one another to determine the next content item 704. In some examples, the group feed component 712 runs on a server such as the interaction server system 110 of FIG. 1. In some examples, the application 734 on one user system 730 may provide the feed functionality as a controller and share the content items 704 with other user systems 730 wirelessly such as by communications 812, 813 of FIG. 8. The other applications 734 of the users 726 sharing in the feed 711 are controlled by the controller application 734, which may be the group feed component 712. The controller application 734 may provide the functionality described herein. The user account 739 is one or more user accounts 739 for interaction platforms 720 or servers that may host the database 702.

The UI module 742 provides the user 726 with items 746, which when selected by the user 726 cause the action 747 to be performed. In some examples, the group feed component 712 determines items 717 and actions 715 and sends them to the user system 730 as the items 746 and actions 747 for the UI module 742. The UI module 742 sends an indication of the selected item 746 to the group feed component 712 or performs the action 747 locally on the user system 730. The UI configuration 716 may determine how the UI module 742 displays the items 746 for the user 726. The notifications 718 are messages sent to the user system 730 such as “interaction platform unavailable,” “user account not valid,” and so forth.

The proximity component 722 determines users 725 that may be added to the active users 710 of the feed component 708. The proximity component 722 uses a location 724 of the user system 730 to locate other user systems 730 that may be close to the user system 730 of the user 726. In some examples, the proximity component 722 detects signals from other user systems 730 such as Low Energy BlueTooth® (BLE) and determines the proximity of the other user system 730 using BLE. The proximity component 722 determines whether a distance between a first user system 730 and a second user system 730 transgresses a threshold proximity distance. In some examples, the proximity component 722 is resident in the user system 730. In some examples, the proximity component 722 runs on a server such as the interaction server system 110 of FIG. 1. In some examples, the proximity component 722 determines users 725 based on the metadata 706, 738 of active users 710 of the feed component 708. In some examples, the proximity component 722 may restrict a user 725 from being considered to be added to the active users 710 based on the permissions 713 and/or configuration 719. For example, the configuration 719 may indicate that only users 725 who are friends with a majority of the active users 710 or all the active users 710 may be considered to become an active user 710. Additionally, the user 725 may be restricted based on age requirements such as the user 725 may have to be over or under eighteen years old.

The group feed component 712 includes a feed component 708 that determines a next content item 704 from the feed 711, which may be database 702, for the active users 710 participating in the group scrollable content. The feed 711 is the source of the content items 704 from which the next content item 704 is selected. The permissions 713 determine the permissions 713 an active user 710 has for controlling the group feed component 712. The feed component 708 determines the next content item 704 based on the content items 704 and metadata 706, 738. The feed component 708 determines the next content item 704 based on the metadata 706, 738 of one or more of the active users 710 that are participating in the group scrollable content. The content items 704 may be on the user system 730 or remotely stored such as in the database 702. The active users 710 may select one or more feeds 711.

The configuration 719 indicates which of the active users 710, which are users 726, should be used to determine the next content item 704. For example, if a user 1, user 2, and user 3, were all active users 710 and participating in the group feed, then the configuration 719 may indicate that the metadata 706, 738 of user 1 and user 2 should be used to determine the next content item 704 and not the metadata 738 of user 3. In some examples, the feed component 708 may determine the next content item 704 based on group metadata 706, 738, which is metadata 706, 738 generated by the active users 710 during one or more sessions of scrolling and viewing content by multiple users.

Additionally, the configuration 719 may include other permissions for each user 726, which may include one or more of: whether a user 726 can control the feed such as advance the feed, reverse the feed, or pause the feed, whether the user 726 can react to the feed, and whether the user 726 can change which interaction platform 720 the feed will come from.

FIG. 8 is a schematic diagram illustrating a system 800 for scrolling and viewing content by multiple users, in accordance with some examples. User 1 system 822 through user N system 824 are user systems 730. User 1 818 through user N 820 are users 726. Interaction platform 1 814 through interaction platform N 816 are interaction platforms 720.

The user 1 system 822 through user N system 824 communicate by sending communications 812, 813 using I/O component 408 of FIG. 4. The wireless network 802 is a cellular telephone network such as an LTE network, 3GPP, an IEEE 802.11 network, a low energy BlueTooth® (BLE) network, the network 438 of FIG. 4, or another wireless network using another wireless communication protocol.

In some examples, User 1 system 822 and user N system 824 communicate directly with the communications 813 rather than via the wireless network 802. The communication protocol of the communications 813 may IEEE 802.11, BLE, or another communication protocol.

The communications protocol for communications 813 may be different than the protocols used for the communications 812. For example, communication 813 may be BlueTooth® and the communications 812 may be 3GPP or IEEE 802.11.

In examples user 1 system 822 sends communications 812, 813 that include metadata 738, content items 704, data indicating actions 747, requests, and/or responses to another device such as user N system 824, interaction platform 1 814, and/or interaction platform N 816. The wireless network 802 may include access to the internet and/or user 1 system 822 through user N system 824 may access the internet via another connected device such as a smartphone (not illustrated).

The proximity component 722 of FIG. 7 may detect communications 813, which may be BLE, and determine that user N system 824 is close to user 1 system 822. The proximity component 722 may then determine whether the user N 820 is associated with user 1 818 such as being a friend within the interaction platform 720. In some examples, the proximity component 722 checks whether user N 820 is friends or associated with user 1 818 within the current feed 711. For example, if the current feed 711 is interaction platform 1 814, then the proximity component 722 would check to see if user N 820 is friends within the interaction platform 1 814 with user 1 818.

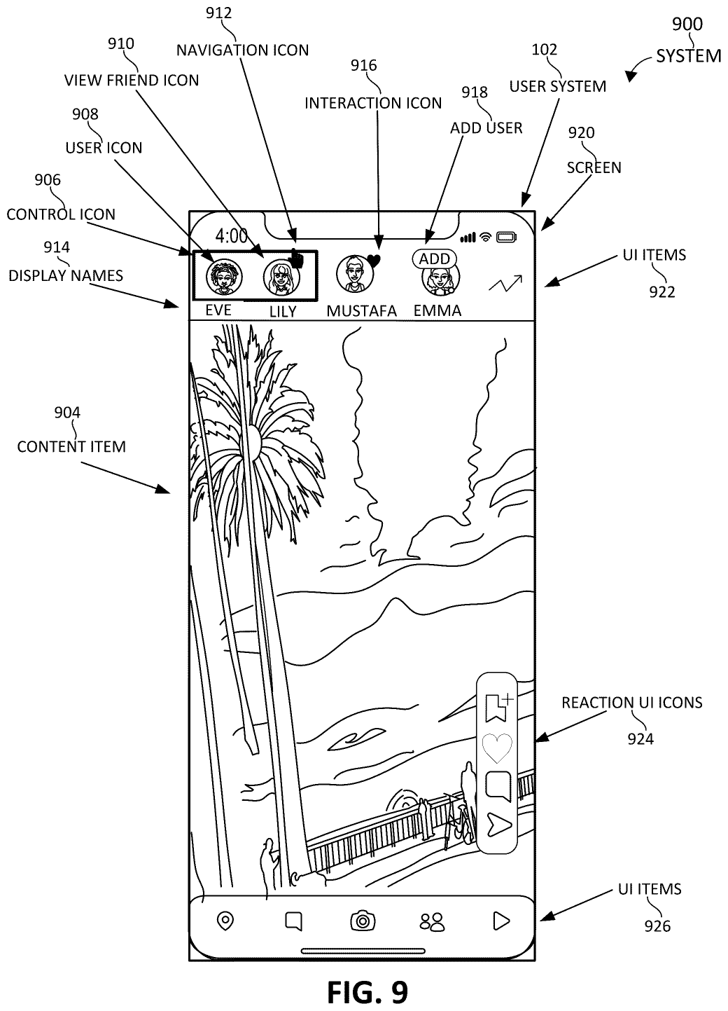

FIG. 9 illustrates a system 900 for scrolling and viewing content by multiple users, in accordance with some examples. Referring to FIGS. 7 and 9, as illustrated, the user system 730 is a user system 102, which include a screen 920. Active users 710 have display names 914 “Eve,” “Lily,” and “Mustafa” and are sharing a feed 711. The active user 710 “Eve” has a user icon 908. The active user 710 “Lily” has view friend icon 910. Each of the active users 710 may have one or more icons associated with their display names 914. In some examples, the user icon 908 and view friend icon 910 may be associated with the interaction platform 720. For example, if “Eve,” “Lily,” and “Mustafa” were logged into an interaction platform 720 then the display icons may be associated with the interaction platform 720 such as stored in the metadata 706 in the database 702. If the active users 710 switch to a new interaction platform 720, then their display names and user icons may change in accordance with the new interaction platform 720.

The control icon 906 indicates the active users 710 who may control the feed 711. For example, the active users 710, “Eve” and “Lily”, inside the rectangle can advance the feed 711 by swiping on the screen 920 with their fingers. Other permissions 713 may be granted to the active users 710 within the control icon 906 such as changing the feed 711.

The navigation icon 912 indicates that “Lily” was the active user 710 who advanced the feed 711 to the current content item 904. The interaction icon 916 indicates “Mustafa” reacted to the current content item 904 with a “heart.” For example, “Mustafa” may have pressed the reaction icon 924 shaped like a “heart.” “Mustafa” is not included within the control icon 906 so he cannot advance the feed 711.

The UI items 926 provide other access to additional actions 747 for either the group feed component 712 or the interaction platform 720. The configuration 719 determines the operation of the group feed component 712. In some examples, the feed 711 is not advanced until each of active users 710 with a permission 713 to advance the feed 711 have indicated they would like the feed 711 advanced. For example, the navigation icon 912 by the view friend icon 910 of “Lilly” may indicate that “Lilly” would like to advance the feed 711. “Eve” has not yet indicated she would like the feed 711 advanced. When “Eve” indicates the feed 711 should be advanced, then the group feed component 712 will determine a next content item 704. In some examples, the active users 710 indicate they would like the feed 711 advanced by selecting a reaction UI icon 924.

The UI items 922 provides other actions 747 when selected such as changing the configuration 719. In some examples, the group feed component 712 in determining the next content item 704 may switch the interaction platform 720 or the source of the content items 704. For example, the content items 704 may be from interaction platform 1 814 and the group feed component 712 may determine to switch to interaction platform N 816. In some examples, the group feed component 712 may take as the source of the content items 704, content items 704 that are associated with one or more the active users 710. For example, the active users 710 may make content items 704 available to the group feed component 712 where the content items 704 may be photos of one of the active users 710.

In some examples, the group feed component 712 operates so it can select content items 704 from the interaction platform 720 in a similar manner in which a user 726 may browse content available on an interaction platform 720.

In some examples, the group feed component 712 selects from content items 704 that other feed applications feed to the active users 710. For example, interaction platform 1 814 may be providing a feed to “Eve” and interaction platform N 816 may be providing a feed to “Lily.” The group feed component 712 examines the content items 704 available from interaction platform 1 814 and interaction platform N 816 and selects the content item 704 based on the metadata 738, 706 and/or the current reactions from the active users 710.

“Emma” is listed with add user 918. The proximity component 722 determined to offer “Emma” as a user 725 who may be added. The configuration 719 and permissions 713 may determine which active users 710 can add “Emma” to the active users 710. In some examples, the active users 710 can select which metadata 706, 738 to use to select the next content item 704. For example, the active users 710 may name and store metadata 706, 738 collected during one or more of their sessions of scrolling and viewing content by multiple users. The active users 710 may also determine which of the metadata 706, 738 associated with the active users 710 to use to determine the next content item 704. For example, use metadata 706, 738 associated with “Lily” only, or metadata 706, 738 associated with “Lily” and metadata 706, 738 generated during the current session of scrolling and viewing content by multiple users.

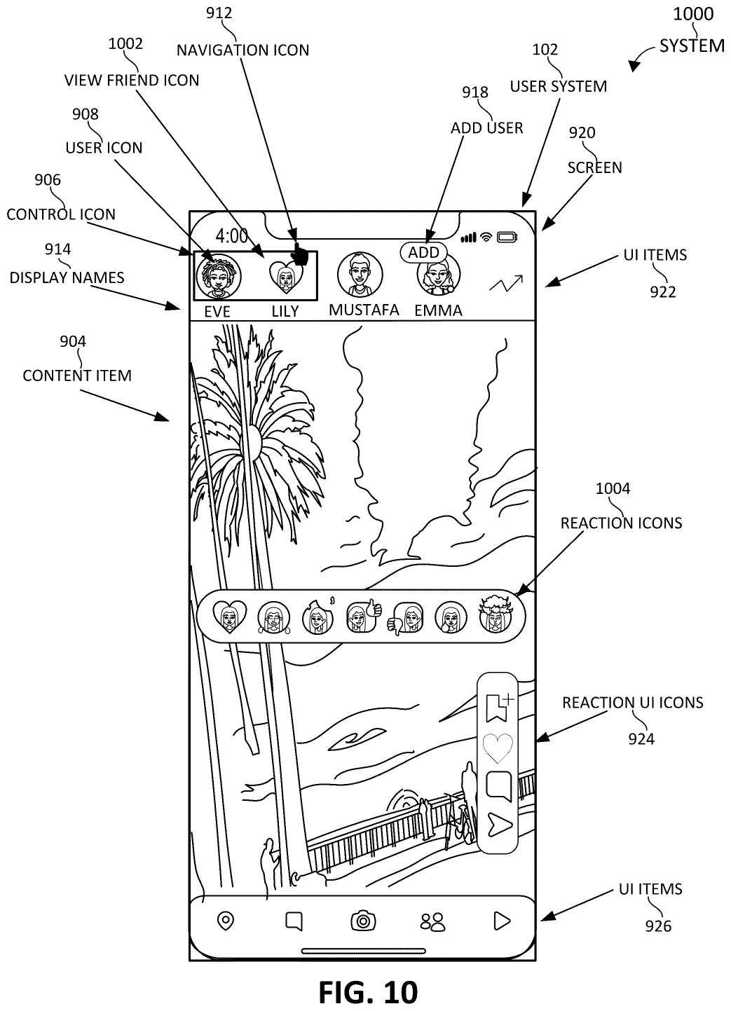

FIG. 10 illustrates a system 1000 for scrolling and viewing content by multiple users, in accordance with some examples. Reaction icons 1004 are displayed by the UI module 742. Example reaction icons 1004 include a “heart”, a “like”, a “dislike”, a “smile”, a “cry”, a “confusion”, and a “hot”. The UI module 742 changes the view friend icon 910 from FIG. 9 to view friend icon 1002 when “Lily” selects the reaction icons 1004 for a “heart.” In some examples, the group feed component 712 does not advance the feed 711 until each of the active users 710 who have permission 713 to react to the content item 704 have reacted to the content item 704.

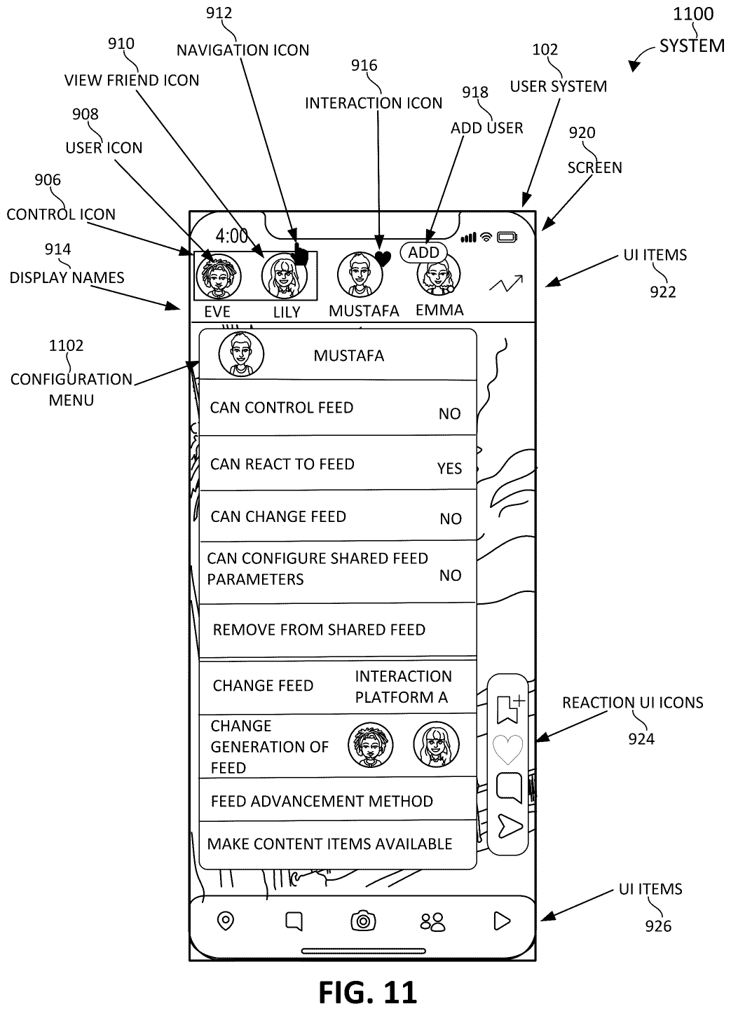

FIG. 11 illustrates a system 1100 for scrolling and viewing content by multiple users, in accordance with some examples. In some examples, the UI module 742 provides a configuration menu 1102 with items 746 for the user 726 to modify the configuration 719 of the group feed component 712. “Eve” is modifying the configuration 719 and the permissions 713 for “Mustafa.” The permissions 713 for “Mustafa” include whether the active user 710 “Mustafa” can control the feed. For example, whether “Mustafa” can advance the content item 704 or pause playing of the current content item 704. Another permission 713 is whether the active user 710 “Mustafa” can react to the feed such as select a reaction icon. Another permission 713 is whether the active user 710 “Mustafa” can change the feed 711 such as from interaction platform 1 814 to interaction platform N 816. Another permission 713 is whether the active user 710 “Mustafa” can change the configuration 719 and/or the permissions 713 for other active users 710. Another permission 713 not listed is whether the active user 710 “Mustafa” can add a user to the active user 710 such as selecting add user 918 to add “Emma” to the active users 710.

The group feed component 712 offers “Eve” the option to remove “Mustafa” from the active users 710. The group feed component 712 offers “Eve” the option to change the feed 711. The feed 711 may be a local feed from the user system 730 of “Eve,” one of the interaction platforms 720, the user system 730 of another active user 710, or from another computing device storing content items 704. The group feed component 712 offers “Eve” the option of changing the generation of the feed 711. For example, the feed 711 may be based on “Eve” being logged into an interaction platform 720 and then the group feed component 712 is using metadata 706, 738 from one or more of the active users 710 to select next content items 704. The feed 711 could be changed to a different interaction platform 720 where “Lilly” is logged into. In some examples, the interaction platform 720 permits access for group scrollable content by permitting access to the metadata 706, 738 for each of the active users 710.

In some examples, the group feed component 712 permits different types of feed advancement methods. For example, a single active user 710 may have the permissions 713 to advance to the next content item 704.

Another feed advancement method is having a threshold number of active users 710 indicate they would like to advance to the next content item 704. Another feed advance method is that each of the active users 710 has to react to the current content item 704. In some examples, the group feed component 712 enables the active user 710 to select which active users 710 metadata 706, 738 should be used in determining the next content item 704.

In some examples, the group feed component 712 enables the active user 710 to select more than one source for the content items 704. For example, the active users 710 may each have a folder of vacation photographs or spring break photographs and the active users 710 may be able to select one or more sources for content items 704 for one or more of the active users 710.

In some examples, the group feed component 712 enables the active user 710 such as “Eve” to make content items 704 available such as the local storage unit 420 of FIG. 4 or a collection of content items 704 stored in the network 438. In some examples, the group feed component 712 enables the active users 710 to vote for a feed 711 from an active user 710. For example, “Eve” and “Lily” may both be logged into an interaction platform 720 and the current content item 704 may be based on “Lily” being logged into an interaction platform 720. This may be indicated on the screen 920. The active users 710 can then select “Eve” to indicate that they would like to switch over to a feed 711 associated with “Eve,” which may be photos that “Eve” has saved. The metadata 706, 738 may enable a more efficient and enjoyable group feed 711 for the active users 710 by accounting for the metadata 706, 738 of the active users 710. For example, if the content items 704 were photographs or images, then the metadata 706, 738 of the active users 710 may indicate that the active users 710 prefer to view content items 704 with people's faces included in the content item 704. The feed component 708 then selects more content items 704 with faces in the content items 704.

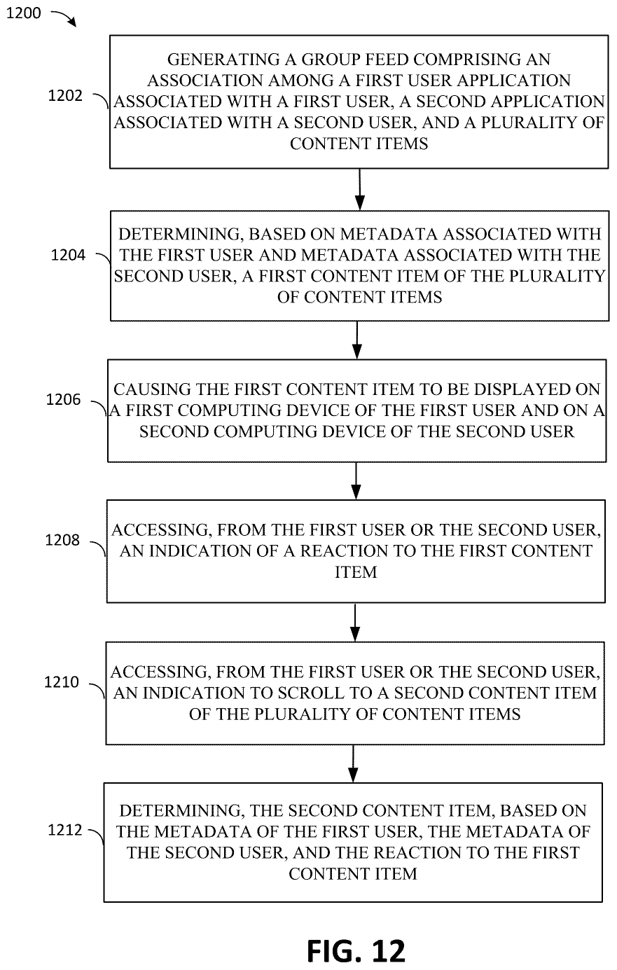

FIG. 12 illustrates a method 1200 for scrolling and viewing content by multiple users, in accordance with some examples. The method 1200 begins at operation 1202 with generating a group feed comprising an association among a first user application associated with a first user, a second application associated with a second user, and a plurality of content items. For example, the feed 711 may be generated with first user and the second user being active users 710, the application 734 being the first application and the second application, and the content items 704 being the content items.

The method 1200 continues at operation 1204 with determining, based on metadata associated with the first user and metadata associated with the second user, a first content item of the plurality of content items. For example, the feed component 708 determines a first content item 704 from the content items 704 based on the metadata 706, 738 associated with a first user 726 and a second user 726.

The method 1200 continues at operation 1206 with causing the first content item to be displayed on a first computing device of the first user and on a second computing device of the second user. For example, the content item 904 of FIG. 9 is being displayed on a user system 102 of a user 726 and may be displayed on the user systems 730 of other users 726.

The method 1200 continues at operation 1208 with accessing, from the first user or the second user, an indication of a reaction to the first content item. For example, “Mustafa” of FIG. 9 selected a reaction UI icon 924 of a “heart.”

The method 1200 continues at operation 1210 with accessing, from the first user or the second user, an indication to scroll to a second content item of the plurality of content items. For example, referring to FIG. 9, “Eve” or “Lily” may swipe the screen 920 of their respective user system 102.

The method 1200 continues at operation 1212 with determining, the second content item, based on the metadata of the first user, the metadata of the second user, and the reaction to the first content item. For example, the feed component 708 of FIG. 7 determines a next content item 704 based on the metadata 706, 738 of a first user 726, a second user 726, and the metadata 706, 738 generated during a session of scrolling and viewing content by multiple users.

The method 1200 optionally includes one or more additional operations, the operations of method 1200 can be performed in a different order, or one or more of the operations of the method 1200 may be optional. The method 1200 may be performed in whole or in part by one or more computing devices, or an apparatus of one or more computing devices disclosed herein. The functions of a component, such as the group feed component 712, are performed or executed by one or more computing devices configured to perform or execute the functions of the component.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” or “module” refers, for example, to a device, physical entity, or logic having boundaries defined by function or subroutine calls, branch points, APIs, or other technologies that provide for the partitioning or modularization of particular processing or control functions. Components or modules may be combined via their interfaces with other components to carry out a machine process. A component or module may be a packaged functional hardware unit designed for use with other components and a part of a program that usually performs a particular function of related functions. Components or modules may constitute either software components (e.g., code embodied on a machine-readable medium) or hardware components. A “hardware component” or “hardware module” is a tangible unit capable of performing certain operations and may be configured or arranged in a certain physical manner. In various examples, one or more computer systems (e.g., a standalone computer system, a client computer system, or a server computer system) or one or more hardware components or software components of a computer system (e.g., a processor or a group of processors) may be configured by software (e.g., an application or application portion) as a hardware component or software component that operates to perform certain operations as described herein. A hardware component or hardware module may also be implemented mechanically, electronically, or any suitable combination thereof. For example, a hardware component hardware module may include dedicated circuitry or logic that is permanently configured to perform certain operations. A hardware component or hardware module may be a special-purpose processor, such as a field-programmable gate array (FPGA) or an application-specific integrated circuit (ASIC). A hardware component or hardware module may also include programmable logic or circuitry that is temporarily configured by software to perform certain operations. For example, a hardware component or hardware module may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component or hardware module mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components or hardware modules can provide information to, and receive information from, other hardware components. Accordingly, the described hardware components or hardware modules may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component or hardware module may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., crasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems. Additional claimable subject matter further includes the following:

Example 1 is a computing device comprising: one or more processors; and one or more computer-readable mediums storing instructions that, when executed by the one or more processors, cause the computing device to perform operations comprising: generating a group feed comprising an association among a first user application associated with a first user, a second application associated with a second user, and a plurality of content items; determining, based on metadata associated with the first user and metadata associated with the second user, a first content item of the plurality of content items; causing the first content item to be displayed on a first computing device of the first user and on a second computing device of the second user; accessing, from the first user or the second user, an indication of a reaction to the first content item; accessing, from the first user or the second user, an indication to scroll to a second content item of the plurality of content items; and determining, the second content item, based on the metadata of the first user, the metadata of the second user, and the reaction to the first content item.

In Example 2, the subject matter of Example 1 includes, wherein the operations further comprise: accessing the plurality of content items on an interaction platform, wherein the first user or the second user is logged into the interaction platform.

In Example 3, the subject matter of Example 2 includes, wherein the operations further comprise: accessing the metadata of the first user and the metadata of the second user on the interaction platform, wherein the first user and the second user are logged into the interaction platform.

In Example 4, the subject matter of any of Examples 1-3 includes, wherein the operations further comprise: accessing an indication from the first user or the second user an indication of a location of the plurality of content items.

In Example 5, the subject matter of any of Examples 1-4 includes, wherein the operations further comprise: generating the group feed to further comprise an association with a third user application associated with a third user.

In Example 6, the subject matter of any of Example 5 includes, wherein the reaction to the first content item is group metadata, and wherein the operations further comprise: in response to determining that at least two of the first user, the second user, and the third user, have indicated to scroll to a third content item, determining the third content item based on the metadata of the first user, the metadata of the second user, the metadata of the third user, and the group metadata.

In Example 7, the subject matter of any of Example 6 includes, wherein the operations further comprise: in response to receiving, from the third user, an indication of a reaction to the third content item, causing to be displayed, on the first computing device, the second computing device, and a third computing device of the third user, a modified icon for the third user, the modified icon indicating the reaction from the third user.

In Example 8, the subject matter of any of Examples 5-7 includes, wherein the operations further comprise: causing to be displayed by the computing device of the first user, an icon for the first user, an icon for the second user, an icon for the third user, and a control icon, the control icon indicating which of the first user, the second user, and third user, can indicate to scroll to a next content item.

In Example 9, the subject matter of any of Examples 1-8 includes, wherein the reaction is at least one of: a heart, a like, a dislike, a smile, a cry, confusion, or hot, and wherein the first content item is at least one of: an image, a video, text, audio, messages, text messages, screens of a social media account, or virtual reality graphics.

In Example 10, the subject matter of any of Examples 1-9 includes, wherein the computing device is the first computing device or the second computing device.

In Example 11, the subject matter of any of Examples 1-10 includes, wherein the operations further comprise: accessing an indication from the first user an indication of a first plurality of content items; accessing an indication from the second user an indication of a second plurality of content items, wherein the plurality of content items is comprised of the first plurality of content items and the second plurality of content items.

In Example 12, the subject matter of any of Example 11 includes, wherein the first plurality of content items are images or videos stored on a first user system associated with the first user.

In Example 13, the subject matter of any of Examples 1-12 includes, wherein the operations further comprise: causing to be displayed on the first computing device an indication of a third user and on the second computing device the indication of the third user; and in response to receiving, an indication that the first user or the second user selects the indication of the third user, generating the group feed to further comprise an association with a third user application associated with the third user.

In Example 14, the subject matter of any of Example 13 includes, wherein the operations further comprise: determining a third computing device associated with the third user application transgresses a threshold distance from the first computing device or the second computing device; and determining the third user is friend of the first user within an interaction platform and a friend of the second user within the interaction platform.

In Example 15, the subject matter of any of Examples 13-14 includes, wherein the operations further comprise: in response to the first user selecting the indication of third user, causing to be displayed user interface items on a screen of the first computing device associated with the first user, the user interface items comprising at least one of: an indication of whether the third user can control a feed of the plurality of content items, an indication of whether the third user can react to content items, or an indication of whether the third user can configure group feed parameters.

In Example 16, the subject matter of any of Examples 1-15 includes, wherein the group feed is a first group feed, and wherein the operations further comprise: storing the reaction to the first content item as a group feed metadata, the group feed metadata comprising a name; and in response to an indication from the first user and the second user, generating a second group feed comprising an association among the first user application associated with the first user, the second application associated with the second user, and a plurality of content items, wherein the second group feed is based on the group feed metadata comprising the name.

Example 17 is a non-transitory computer-readable storage medium including instructions that, when processed by one or more processors of a computing device, configure the computing device to perform operations comprising: generating a group feed comprising an association among a first user application associated with a first user, a second application associated with a second user, and a plurality of content items; determining, based on metadata associated with the first user and metadata associated with the second user, a first content item of the plurality of content items; causing the first content item to be displayed on a first computing device of the first user and on a second computing device of the second user; accessing, from the first user or the second user, an indication of a reaction to the first content item; accessing, from the first user or the second user, an indication to scroll to a second content item of the plurality of content items; and determining, based on the metadata of the first user, the metadata of the second user, and the reaction to the first content item, the second content item.

In Example 18, the subject matter of any of Example 17 includes, wherein the operations further comprise: accessing the plurality of content items on an interaction platform, wherein the first user or the second user is logged into the interaction platform.

Example 19 is a method performed by a computing device, the method comprising: generating a group feed comprising an association among a first user application associated with a first user, a second application associated with a second user, and a plurality of content items; determining, based on metadata associated with the first user and metadata associated with the second user, a first content item of the plurality of content items; causing the first content item to be displayed on a first computing device of the first user and on a second computing device of the second user; accessing, from the first user or the second user, an indication of a reaction to the first content item; accessing, from the first user or the second user, an indication to scroll to a second content item of the plurality of content items; and determining, based on the metadata of the first user, the metadata of the second user, and the reaction to the first content item, the second content item.

In Example 20, the subject matter of Example 19 includes, wherein the method further comprises: accessing the plurality of content items on an interaction platform, wherein the first user or the second user is logged into the interaction platform.

Example 21 is at least one machine-readable medium including instructions that, when executed by processing circuitry, cause the processing circuitry to perform operations to implement of any of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A computing device comprising:
one or more processors; and
one or more computer-readable mediums storing instructions that, when executed by the one or more processors, cause the computing device to perform operations comprising:
generating a group feed comprising an association among a first user application associated with a first user, a second application associated with a second user, and a plurality of content items;
determining, based on metadata associated with the first user and metadata associated with the second user, a first content item of the plurality of content items;
causing the first content item to be displayed on a first computing device of the first user and on a second computing device of the second user;
accessing, from the first user or the second user, an indication of a reaction to the first content item;
accessing, from the first user or the second user, an indication to scroll to a second content item of the plurality of content items; and
determining, the second content item, based on the metadata of the first user, the metadata of the second user, and the reaction to the first content item.

2. The computing device of claim 1, wherein the operations further comprise:
accessing the plurality of content items on an interaction platform, wherein the first user or the second user is logged into the interaction platform.

3. The computing device of claim 2, wherein the operations further comprise:
accessing the metadata of the first user and the metadata of the second user on the interaction platform, wherein the first user and the second user are logged into the interaction platform.

4. The computing device of claim 1, wherein the operations further comprise:
accessing an indication from the first user or the second user an indication of a location of the plurality of content items.

5. The computing device of claim 1, wherein the operations further comprise:
generating the group feed to further comprise an association with a third user application associated with a third user.

6. The computing device of claim 5, wherein the reaction to the first content item is group metadata, and wherein the operations further comprise:
in response to determining that at least two of the first user, the second user, and the third user, have indicated to scroll to a third content item, determining the third content item based on the metadata of the first user, the metadata of the second user, the metadata of the third user, and the group metadata.

7. The computing device of claim 6, wherein the operations further comprise:
in response to receiving, from the third user, an indication of a reaction to the third content item, causing to be displayed, on the first computing device, the second computing device, and a third computing device of the third user, a modified icon for the third user, the modified icon indicating the reaction from the third user.

8. The computing device of claim 5, wherein the operations further comprise:
causing to be displayed by the computing device of the first user, an icon for the first user, an icon for the second user, an icon for the third user, and a control icon, the control icon indicating which of the first user, the second user, and third user, can indicate to scroll to a next content item.

9. The computing device of claim 1, wherein the reaction is at least one of: a heart, a like, a dislike, a smile, a cry, confusion, or hot, and wherein the first content item is at least one of: an image, a video, text, audio, messages, text messages, screens of a social media account, or virtual reality graphics.

10. The computing device of claim 1, wherein the computing device is the first computing device or the second computing device.

11. The computing device of claim 1, wherein the operations further comprise:
accessing an indication from the first user an indication of a first plurality of content items;
accessing an indication from the second user an indication of a second plurality of content items, wherein the plurality of content items is comprised of the first plurality of content items and the second plurality of content items.

12. The computing device of claim 11, wherein the first plurality of content items are images or videos stored on a first user system associated with the first user.

13. The computing device of claim 1, wherein the operations further comprise:
causing to be displayed on the first computing device an indication of a third user and on the second computing device the indication of the third user; and
in response to receiving, an indication that the first user or the second user selects the indication of the third user, generating the group feed to further comprise an association with a third user application associated with the third user.

14. The computing device of claim 13, wherein the operations further comprise:
determining a third computing device associated with the third user application transgresses a threshold distance from the first computing device or the second computing device; and
determining the third user is friend of the first user within an interaction platform and a friend of the second user within the interaction platform.

15. The computing device of claim 13, wherein the operations further comprise:
in response to the first user selecting the indication of third user, causing to be displayed user interface items on a screen of the first computing device associated with the first user, the user interface items comprising at least one of: an indication of whether the third user can control a feed of the plurality of content items, an indication of whether the third user can react to content items, or an indication of whether the third user can configure group feed parameters.

16. The computing device of claim 1, wherein the group feed is a first group feed, and wherein the operations further comprise:
storing the reaction to the first content item as a group feed metadata, the group feed metadata comprising a name; and
in response to an indication from the first user and the second user, generating a second group feed comprising an association among the first user application associated with the first user, the second application associated with the second user, and a plurality of content items, wherein the second group feed is based on the group feed metadata comprising the name.

17. A non-transitory computer-readable storage medium including instructions that, when processed by one or more processors of a computing device, configure the computing device to perform operations comprising:
generating a group feed comprising an association among a first user application associated with a first user, a second application associated with a second user, and a plurality of content items;
determining, based on metadata associated with the first user and metadata associated with the second user, a first content item of the plurality of content items;
causing the first content item to be displayed on a first computing device of the first user and on a second computing device of the second user;
accessing, from the first computing device or the second computing device, an indication of a reaction to the first content item;
accessing, from the first computing device or the second computing device, an indication to scroll to a second content item of the plurality of content items; and
determining, based on the metadata of the first user, the metadata of the second user, and the reaction to the first content item, the second content item.

18. The non-transitory computer-readable storage medium of claim 17, wherein the operations further comprise:
accessing the plurality of content items on an interaction platform, wherein the first user or the second user is logged into the interaction platform.

19. A method performed by a computing device, the method comprising:
generating a group feed comprising an association among a first user application associated with a first user, a second application associated with a second user, and a plurality of content items;
determining, based on metadata associated with the first user and metadata associated with the second user, a first content item of the plurality of content items;
causing the first content item to be displayed on a first computing device of the first user and on a second computing device of the second user;
accessing, from the first user or the second user, an indication of a reaction to the first content item;
accessing, from the first user or the second user, an indication to scroll to a second content item of the plurality of content items; and
determining, based on the metadata of the first user, the metadata of the second user, and the reaction to the first content item, the second content item.

20. The method of claim 19, wherein the method further comprises:
accessing the plurality of content items on an interaction platform, wherein the first user or the second user is logged into the interaction platform.
